(19) United States
(12) Patent Application Publication
(10) Pub. No.: US 2009/0067190 A1
(43) Pub. Date: Mar. 12, 2009

(54) Optical Film and Backlight Unit Using the Same

(75) Inventors: Yohei Funabashi, Saitama (JP); Yasumaro Toshima, Saitama (JP)

Correspondence Address: BACON & THOMAS, PLLC, 625 SLATERS LANE, FOURTH FLOOR, ALEXANDRIA, VA, 22314-1176, US

(73) Assignee: KIMOTO CO., LTD., Tokyo (JP)

(21) Appl. No.: 12/087,334

(22) PCT Filed: Jan. 5, 2007
(86) PCT No.: PCT/JP2007/050016

§ 371 Date: Jul. 2, 2008

(30) Foreign Application Priority Data
Jan. 24, 2006 (JP) 2006-014806

(51) Int. Cl. F21V 8/00; G02B 5/08

(52) U.S. Cl. 362/558; 359/599; 362/618

(57) ABSTRACT

An optical film enhances provide brightness in the frontal direction and light diffusing without using a prism sheet or a lens sheet.

Two laminates each produced by providing a light diffusing layer formed from acrylic resin particles and a styrene acrylic copolymer resin binder on a transparent support are superimposed to form the optical film. The styrene acrylic copolymer resin binder preferably has a glass transition temperature of 40° C. or higher. The light diffusing layer 12 preferably contains an acrylic resin binder having a glass transition temperature of 30° C. or lower.

### TECHNICAL FIELD

The present invention relates to a backlight unit suitably used for use in liquid crystal displays and so forth, and an optical film suitably used as a member constituting the backlight unit.

### BACKGROUND ART

In liquid crystal displays and so forth, backlight units of the edge light type and the direct type are conventionally used. Since backlight units of the edge light type themselves can be manufactured with a small thickness, they are used for notebook computers etc., and backlight units of the direct type are used for large-sized liquid crystal televisions etc. in many cases.

These conventional backlight units project a lot of light components inclining from the right frontal direction. In particular, backlight units of the edge light type project a lot of light components greatly inclining from the right frontal direction.

Therefore, in order to increase brightness for the frontal direction of liquid crystal displays, optical members such as prism sheets and lens sheets are disposed on the light projection side of light guide plates in the conventional backlight units (Patent document 1).

[Patent document 1] Japanese Patent Unexamined Publication (KOKAI) No. 5-203947 (claims)

### DISCLOSURE OF THE INVENTION

### Object to be Achieved by the Invention

However, prism sheets and lens sheets have problems, for example, they are expensive, surfaces thereof easily suffer from scratches, and therefore handling thereof is difficult. In addition, they also have a problem that they are likely to show interference-like patterns or glares due to regularly arranged convexes.

Therefore, an object of the present invention is to provide an optical film which can provide favorable brightness for the frontal direction and light diffusing property without using a prism sheet having such problems as mentioned above.

### Means for Achieving the Object

In order to achieve the aforementioned object, the inventors of the present invention conducted various researches on materials and structures of optical film. As a result, they found that brightness for the frontal direction could be improved by superimposing two or more optical films, and brightness for the frontal direction was more improved by increasing number of films to be superimposed, but if a particular material was used, high brightness for the frontal direction could be attained with fewer films to be superimposed, and accomplished the present invention.

That is, the optical film of the present invention is characterized by comprising superimposed two laminates each comprising a transparent support and a light diffusing layer formed from acrylic resin particles and a styrene acrylic copolymer resin binder and provided on the transparent support.

In the optical film of the present invention, the styrene acrylic copolymer resin binder preferably has a glass transition temperature of 40° C. or higher.

In the optical film of the present invention, the light diffusing layer preferably contains an acrylic resin binder having a glass transition temperature of 30° C. or lower.

Further, the backlight unit of the present invention comprises a light guide plate having a light source at least at one end of the plate and a surface substantially perpendicular to the end as a light projection surface and an optical member disposed on the light projection surface of the light guide plate, wherein the optical film the present invention is used as the optical member.

Alternatively, the backlight unit of the present invention comprises a light source, a light diffusing material disposed on one side of the light source, and an optical member disposed on the side of the light diffusing material opposite to the light source side, wherein the optical film of the present invention is used as the optical member.

### EFFECT OF THE INVENTION

Since the optical film of the present invention has a configuration that two of laminates each having a special composition are superimposed, it can provide favorable brightness for the frontal direction and favorable light diffusing property. Since the backlight unit of the present invention utilizes the optical film of the present invention as an optical member, the backlight unit can provide favorable brightness for the frontal direction and favorable light diffusing property, and in addition, it can solve the problem of glares and lessen generation of scratches as seen in the case of using a prism sheet alone.

### BEST MODE FOR CARRYING OUT THE INVENTION

Hereafter, embodiments of the optical film of the present invention will be explained.

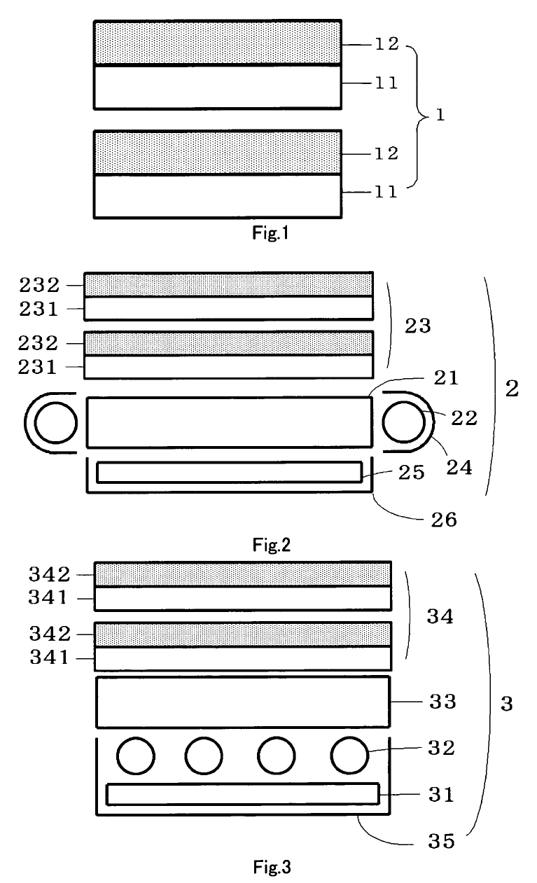

FIG. 1 is a sectional view showing one embodiment of the optical film 1 of the present invention, and this optical film 1 have a configuration that there are superimposed two laminates each comprising a transparent support 11 and a light diffusing layer 12 formed from acrylic resin particles and a styrene acrylic copolymer resin binder and provided on the transparent support. With this configuration that two laminates each having a particular composition are superimposed, an optical film providing favorable brightness for the frontal direction and favorable light diffusing property can be obtained.

The term “superimpose” referred to in the present invention means that two of the laminates are superimposed so that there should be an air gap between the laminates. In order to provide an air gap between the two laminates, for example, a spacer may be provided between the laminates to give a predetermined interval between them, or they may be simply superimposed. Further, although the air gap preferably exists over the entire superimposed area of the two laminates, the air gap may exist over a part of the area except for peripheral areas thereof. For example, only peripheral areas of the two laminates may be adhered with an adhesive. However, if the entire surfaces of the two laminates are adhered with an adhesive, there should be no air gap between them, and such a configuration is not encompassed within the meaning of “superimpose” used in the present invention. Further, the laminates are preferably superimposed so that the light diffusing layer side of one laminate and the side of the other laminate opposite to the light diffusing layer side should face each other.

Each laminate preferably has a haze (JIS K7136:2000) of 85% or more, more preferably 90 to 99%, and a total light transmission (JIS K7361-1:1997) of 90% or more, more preferably 95% or more, as measured for one laminate. With a haze and a total light transmission within such ranges, favorable brightness for the frontal direction and favorable light diffusing property can be obtained.

Each element of the laminate constituting the optical film of the present invention will be explained below.

As the support of the laminate, any transparent support may be used without particular limitation. As such a transparent support, for example, transparent plastic films consisting of polyethylene terephthalate, polybutylene terephthalate, polyethylene naphthalate, polycarbonate, polyethylene, polypropylene, polystyrene, triacetyl cellulose, acrylic resin, polyvinyl chloride or the like can be used. Among these, a stretched, especially biaxially stretched, polyethylene terephthalate film is preferred in view of superior mechanical strength and dimensional stability thereof. Moreover, a support of which surface is subjected to a corona discharge treatment or a support provided with an easy adhesion layer on a surface thereof is also preferably used in order to improve adhesion to the light diffusing layer. The transparent support has a thickness of about 25 to 400 μm.

The light diffusing layer of the laminate is formed at least from acrylic resin particles and a styrene acrylic copolymer resin binder. With a light diffusing layer having such a composition, an optical film capable of providing favorable brightness for the frontal direction and favorable light diffusing property can be obtained.

The acrylic resin particles form convexes and concaves on the surface of the light diffusing layer to provide external haze, and provide internal haze by difference in refractive index from that of the binder resin, and plays a role of providing favorable brightness for the frontal direction and favorable light diffusing property by the actions of these external haze and internal haze.

The acrylic resin particles are not particularly limit so long as they are particles formed from a material containing a resin usually called an acrylic resin. However, true spherical particles of polymethyl methacrylate are preferably used. The acrylic resin of the acrylic resin particles is preferably crosslinked with divinylbenzene or the like from viewpoints of heat resistance, solvent resistance and thermal stability.

The acrylic resin particles preferably have a mean particle size of 10 to 30 μm, more preferably 15 to 22 μm. By using acrylic resin particles having a mean particle size in such a range, brightness for the frontal direction can be made favorable.

The acrylic resin particles preferably show a variation coefficient for particle size distribution of 10 to 40%, more preferably 15 to 30%. By using acrylic resin particles showing a variation coefficient for particle size distribution of 10 to 40%, brightness for the frontal direction and light diffusing property can be made favorable. The variation coefficient is a value representing a variance state in particle size distribution, and is a percentage of a value obtained by dividing a standard deviation for particle size distribution (square root of unbiased variance) with an arithmetic average value of particle sizes (mean particle size).

Content of the acrylic resin particles changes depending on mean particle size of the particles or thickness of the light diffusing layer, and it cannot generally be defined. However, it is preferably 180 to 270 parts by weight, more preferably 200 to 250 parts by weight, with respect to 100 parts by weight of the binder. With a content of 180 parts by weight or more, an optical film providing favorable brightness for the frontal direction and favorable light diffusing property can be obtained, and with a content of 270 parts by weight or less, reduction of strength of the coated film can be prevented.

The styrene acrylic copolymer resin binder functions as a binder holding the acrylic resin particles. Such a resin can be obtained by copolymerizing acrylic type monomers (or acrylic type resin) and styrene type monomers (or styrene type resin). Alternatively, it may be a polymer obtained by graft-polymerizing styrene type monomers on side chains of an acrylic type resin, or graft-polymerizing acrylic type monomers on side chains of a styrene type resin.

Typical examples of the acrylic type monomers include, for example, methacrylate type monomers such as methyl methacrylate and ethyl methacrylate, acrylate type monomers such as methyl acrylate and ethyl acrylate, hydroxyethyl methacrylate, acrylamide, and so forth, and typical examples of the styrene type monomers include styrene, a-methylstyrene, vinyltoluene, and so forth. When these monomers are copolymerized, these monomers as the main components and other monomers may be copolymerized, if needed.

Ratio of the styrene type component and the acrylic type component in the styrene acrylic copolymer resin is preferably 1:4 to 4:1 in terms of weight ratio. By choosing the ratio to be within such a range, brightness for the frontal direction and light diffusing property of the optical film can be made favorable.

The styrene acrylic copolymer resin binder preferably has a glass transition temperature of 40° C. or higher, more preferably a glass transition temperature of 70° C. or higher. By using a resin binder having a glass transition temperature of 40° C. or higher, brightness for the frontal direction and light diffusing property of the optical film can be made favorable.

The glass transition temperature can be adjusted by suitably changing polymerization degree of the resin, ratio of the acrylic type component and the styrene type component in the resin, and the like. For example, a homopolymer of styrene has a glass transition temperature of 100° C., and by choosing acrylic type monomers to be copolymerized with styrene, the glass transition temperature can be adjusted. Further, it is known that there are acrylic type monomers having a glass transition temperature of from 0° C. or lower to 100° C. or higher, and the glass transition temperature can be adjusted by choosing type of the acrylic type component. For example, a copolymer of styrene (St):methyl methacrylate (MMA):butyl acrylate (BA)=20:55:25 has a glass transition temperature of 46.2° C. (calculated value), but a glass transition temperature of 78.5° C. (calculated value) can be obtained with the same components at a copolymerization ratio of St:MMA:BA=20:70:10.

Ratio of the styrene acrylic copolymer resin binder in the total resin binder of the light diffusing layer is preferably 20% or more, more preferably 40% or more. By using the binder in such a range, brightness for the frontal direction and light diffusing property of the optical film can be made favorable.

The resin binder of the light diffusing layer preferably contains an acrylic resin binder having a glass transition temperature of 30° C. or lower in addition to the styrene acrylic copolymer resin binder mentioned above. By adding an acrylic resin binder having a glass transition temperature of 30° C. or lower as a binder, brightness for the frontal direction and light diffusing property of the optical film can be made favorable, and generation of curl in each laminate can be prevented. The acrylic resin binder more preferably has a glass transition temperature of 20° C. or lower.

Examples of monomers of the acrylic resin having a glass transition temperature of 30° C. or lower include the same monomers as the aforementioned acrylic type monomers used for the styrene acrylic copolymer resin, and by appropriately changing of types of these acrylic type monomers, or ratios of these acrylic type monomers or the like when two or more kinds of monomers are used, the glass transition temperature can be adjusted to 30° C. or lower. Examples of commercially available acrylic resins having a glass transition temperature of 30° C. or lower include, for example, those marketed by Dainippon Ink & Chemicals Inc. with trade names of ACRYDIC A811 (Tg: 19° C.), ACRYDIC 49-394IM (Tg: 16° C.), ACRYDIC 52-614 (Tg: 16° C.), ACRYDIC 48-261 (Tg: 30° C.), and so forth.

When a combination of the styrene acrylic copolymer resin binder and the acrylic resin binder having a glass transition temperature of 30° C. or lower is used as the resin binder of the light diffusing layer, the weight ratio of the resins of the former and the latter is preferably in the range of 1:4 to 4:1, more preferably in the range of 1:3 to 3:1. By using 4 parts by weight or less of the acrylic resin binder having a glass transition temperature of 30° C. or lower with 1 part by weight of the styrene acrylic copolymer resin binder, brightness for the frontal direction and light diffusing property can be made favorable, and by using 1 part by weight or more of the acrylic resin binder having a glass transition temperature of 30° C. or lower with 4 parts by weight of the styrene acrylic copolymer resin binder, anti-curl property can be made favorable.

Even when the styrene acrylic copolymer resin binder and the acrylic resin binder having a glass transition temperature of 30° C. or lower are used in combination, the light diffusing layer may also contain a resin binder other than those as a resin binder of the light diffusing layer. However, the total ratio of the styrene acrylic copolymer resin binder and the acrylic resin binder having a glass transition temperature of 30° C. or lower is preferably 60% or more, more preferably 70% or more, based on the total resin binders of the light diffusing layer. By using them in such a range, advantages of mixing of two kinds of resins can be effectively obtained.

As the other resin binders, curing agents such as isocyanate type compounds and melamine type compounds, and so forth can be used. By adding a curing agent in a range not exceeding 40%, performances including adhesion to the support, strength of coated film, solvent resistance and so forth can be improved.

Although thickness of the light diffusing layer is not particularly limited, it is preferably 15 to 50 μm, more preferably 20 to 40 μm.

The light diffusing layer may contain surfactants such as leveling agents and antifoams, additives such as anti-oxidants and ultraviolet absorbers, and other resins, so long as the performances mentioned above are not degraded.

The light diffusing layer can be formed by applying a coating dispersion prepared by dissolving or dispersing materials constituting that layer such as the resin particles and the resin in a suitable solvent on a support according to a known coating method such as bar coating, and drying it.

The surface of the laminate opposite to the surface of the light diffusing layer side may be subjected to a fine matting treatment, or a backcoat layer may be formed on that surface in order to prevent adhesion with another laminate or other members (light guide plate etc.). Further, an anti-curl layer may be provided on that surface in order to prevent generation of curl, or the surface is subjected to an anti-reflection treatment in order to improve light transmittance. A backcoat layer also serving as an anti-curl layer may also be provided.

The optical film of the present invention comprises two superimposed laminates mentioned above, and the laminates may be the same or different. For example, laminates prepared by providing the same light diffusing layers on supports different in thickness may be combined, or laminates prepared by providing light diffusing layers different in the ratio of the acrylic resin particles and the resin binder on the same supports may be combined.

Since the thickness of the optical film (total thickness of the two laminates) changes depending on use thereof, it cannot be generally defined. However, it is usually less than 1 mm. It is used in a thickness of about 150 to 800 μm in many cases.

The optical film of the present invention explained above is used mainly as one part of a backlight unit constituting a light source of a liquid crystal display, illumination signboard, scanner or copying machine.

Hereafter, embodiments of the backlight unit of the present invention will be explained.

A backlight unit of the edge light type is shown in FIG. 2, which is an embodiment of the backlight unit of the present invention.

The backlight unit of the edge light type comprises, as shown in FIG. 2, a light guide plate 21 having a light source 22 disposed at least at one end of the plate and a surface substantially perpendicular to the end as a light projection surface and an optical member 23 disposed on the light projection surface of the light guide plate. Although a backlight unit having light sources 22 disposed at both ends is shown in the drawing, a light source may be disposed at one end, or light sources may be disposed at ends other than the both facing ends. In the backlight unit of the present invention, the optical film of the present invention mentioned above is used as the optical member 23. The optical film is preferably used so that the surface of the side of the light diffusing layer 232 should be the light projection surface as shown in the drawing. With such a configuration, there can be obtained a backlight unit showing superior balance of brightness for the frontal direction and light diffusing property (viewing angle) and no glare, which is generated if a prism sheet is used.

The light guide plate 21 has a substantially flat plate shape which is molded so that at least one side thereof should be a light entering surface and another surface substantially perpendicular to the light entering surface should be a light projection surface, and consists of a matrix resin mainly selected from highly transparent resins such as polymethyl methacrylate. Moreover, resin particles having a refractive index different from that of the matrix resin may be added to the light guide plate, if needed. Each surface of the light guide plate may have a complicated surface profile, not a flat plane, and may have a diffusion printing layer such as dot patterns.

As the light source 22, a cold cathode tube or LED can be used. In the configuration shown in the drawing, the light source 22 is covered by a light source rear reflector 24 except for the part facing the light guide plate 21 in order that the light from the light source 22 should efficiently enter into the light guide plate 21.

The backlight unit of the edge light type may further comprise a light reflector, a polarization film, an electromagnetic wave shield film and so forth depending on use thereof, in addition to the optical film 23, the light guide plate 22 and the light source 21 mentioned above. Moreover, in order to further improve brightness for the frontal direction, another laminate or a prism sheet may further be used. In the configuration shown in FIG. 2, a light reflector 25 contained in a chassis 26 is disposed under the light guide plate 21. Light projected to the side opposite to the light projection side of the light guide plate 21 is thereby returned to the light guide plate again to increase projection light from the light projection side of the light guide plate 21.

A backlight unit of the direct type is shown in FIG. 3, which is an embodiment of the backlight unit of the present invention. This backlight unit 3 has a structure that, as shown in the drawing, multiple light sources 32 are disposed over a light reflector 31 contained in a chassis 35, and a light diffusion material 33 and an optical film 34 are disposed thereover in this order. The optical member 34 is the optical film of the present invention mentioned above, and in this case, the optical film 34 is disposed so that the surface of the side of the light diffusing layer 342 should be a light projection surface as shown in the drawing. With the above-described arrangement, there can be obtained a backlight unit showing superior balance of brightness for the frontal direction and light diffusing property (viewing angle) and no glare, which is generated if a prism sheet is used.

The light diffusion material 31 is for erasing patterns of the light source 33, and a translucent resin plate or the like can be used. The light diffusion material 31 is used for erasing patterns of the light source 33, and has a thickness as thick as 1 to 10 mm. Therefore, it is different from the thin optical film 34 used in order to give moderate light diffusing property and improve brightness for the frontal direction, and having a thickness less than 1 mm.

The light source 32 is not particularly limited, and a cold cathode tube or LED can be used.

The backlight unit of the direct type may further comprise a polarization film, an electromagnetic wave shield film and so forth depending on use thereof, in addition to the optical film, the light diffusing material and the light sources mentioned above. Moreover, in order to further improve brightness for the frontal direction, another laminate or a prism sheet may further be used.

As explained above, since the backlight unit of the present invention uses a specific optical film as an optical member for controlling direction of light projected from a light source or a light guide plate, it can provide favorable brightness for the frontal direction and favorable light diffusing property, and can eliminate or reduce the problem of glares and generation of scratches, which are seen when a prism sheet alone is used.

### EXAMPLES

Hereafter, the present invention will be further explained with reference to examples. The term and symbol “part” and “%” are used on weight basis, unless especially indicated.

### 1. Production of Optical Films

### Example 1

On a base material consisting of a polyester film having a thickness of 100 μm (Lumirror T60, Toray Industries, Inc.), a coating dispersion (a) for light diffusing layer having the following composition was applied by bar coating so as to obtain a dry thickness of 25 μm, and dried at 110° C. for 2 minutes to form a light diffusing layer. Then, on the surface of the polyester film opposite to the surface having the light diffusing layer, a coating dispersion (b) for backcoat layer having the following composition was applied by bar coating so as to obtain a dry thickness of 5 μm, and dried at 110° C. for 2 minutes to form a backcoat layer and thereby produce a laminate. Another laminate was produced in the same manner, and then the two laminates were superimposed so that the backcoat layer of one of the laminates and the light diffusing layer of the other laminate should face to each other to obtain an optical film of Example 1.

<Coating dispersion (a) for light diffusing layer>

| | |
|---|---|
| Styrene acrylic copolymer resin | 12.3 parts |
| (ACRYDIC A-817, Dainippon Ink & Chemicals, Inc., | |
| solid content: 50%, glass transition temperature: 96° C., | |
| content of styrene type component: 35%) | |
| Acrylic resin | 12.3 parts |
| (ACRYDIC A-811, Dainippon Ink & Chemicals, Inc., | |
| solid content: 50%, glass transition temperature: 19° C.) | |
| Isocyanate type curing agent | 4.5 parts |
| (Takenate D110N, Mitsui Takeda Chemicals, Inc., | |
| solid content: 60%) | |
| Acrylic resin particles | 33.0 parts |
| (polymethyl methacrylate true spherical particles, | |
| mean particle size: 18 μm, variation coefficient: 22%) | |
| Butyl acetate | 42.5 parts |
| Methyl ethyl ketone | 28.5 parts |

<Coating dispersion (b) for backcoat layer>

| | |
|---|---|
| Acrylic polyol (ACRYDIC A-807, | 162 parts |
| Dainippon Ink & Chemicals, Inc., solid content: 50%) | |
| Isocyanate type curing agent | 32 parts |
| (Takenate D110N, Mitsui Takeda Chemicals, Inc., | |
| solid content: 60%) | |
| Polyethylene wax dispersion | 30 parts |
| (mean particle size: 3 μm, solid content: 10%) | |
| Butyl acetate | 200 parts |
| Methyl ethyl ketone | 200 parts |

### Example 2

An optical film of Example 2 was obtained in the same manner as that of Example 1 except that the amounts of the styrene acrylic copolymer resin, the acrylic resin and the isocyanate type curing agent in the coating dispersion (a) for light diffusing layer of Example 1 were changed to 18 parts, 6 parts and 5 parts, respectively.

### Example 3

An optical film of Example 3 was obtained in the same manner as that of Example 1 except that the amounts of the styrene acrylic copolymer resin, the acrylic resin and the isocyanate type curing agent in the coating dispersion (a) for light diffusing layer of Example 1 were changed to 6.3 parts, 18.9 parts and 4 parts, respectively.

Each of the laminates constituting the optical films of Examples 1 to 3 obtained as described above showed no curl at all.

### Example 4

An optical film of Example 4 was obtained in the same manner as that of Example 1 except that, in the coating dispersion (a) for light diffusing layer of Example 1, the amounts of the styrene acrylic copolymer resin and the isocyanate type curing agent were changed to 23.4 parts and 5.5 parts, respectively, and the acrylic resin was not added.

### Example 5

An optical film of Example 5 was obtained in the same manner as that of Example 1 except that, in the coating dispersion (a) for light diffusing layer of Example 1, ACRYDIC 55-129 (Dainippon Ink & Chemicals, Inc., solid content: 65%, glass transition temperature: 57° C., content of styrene type components: 42%) was used in am amount of 17.3 parts instead of the styrene acrylic copolymer resin, the amount of the isocyanate type curing agent was changed to 5.5 parts, and the acrylic resin was not added.

Each of the laminates constituting the optical films of Examples 4 and 5 obtained as described above showed such slight curl that the light diffusing layer side was dented.

### Comparative Examples 1 to 5

Commercially available laminates A to E were prepared. All of the laminates A to E had a configuration that a light diffusing layer was provided on one surface of a transparent support and a backcoat layer was provided on the other surface of the support. All of the light diffusing layers of the laminate A to E comprised acrylic resin particles and an acrylic resin binder. Two of the laminates A were superimposed so that the light diffusing layer side of one of the laminates A and the side of the other laminate A opposite to the light diffusing layer side (backcoat layer side) should face each other to obtain an optical film of Comparative Example 1. Two each of the laminates B to E were superimposed in the same manner, respectively, to obtain optical films of Comparative Examples 2 to 5. Further, three of the laminates A were superimposed so that the light diffusing layer sides thereof should face the same direction to obtain an optical film of Comparative Example 6. Three each of the laminates B to E were superimposed in the same manner, respectively, to obtain optical films of Comparative Examples 7 to 10.

### 2. Production of Edge Light Type Backlight Units

The optical films of Examples 1 to 5 and Comparative Examples 1 to 10 were each built into a 15-inch edge light type backlight unit (1 inch=2.54 cm) comprising one cold cathode tube each on the up side and down side, and brightness was measured. Specifically, each optical film was installed on a light guide plate so that the surface of the film on the light diffusing layer side should serve as a light projection surface, and brightness was measured at the center of the backlight unit for the frontal direction and directions inclined by various light projection angles and parallel to the long side direction of the center of the backlight unit. The results obtained for the optical films of Examples 1 to 5 and Comparative Examples 1 to 10 are shown in Table 1 (unit is “cd/m²”). In addition, the results of the same measurement of brightness obtained by installing one each of the laminates used in Examples 1 to 5 and Comparative Examples 1 to 5 on the light guide plate, respectively, are also shown as results of Reference Examples 1 to 10.

TABLE 1

| | Brightness (cd/m²) | | | | |
|---|---|---|---|---|---|
| | Left | Left | Front | Right | Right |
| | 45° | 30° | (0°) | 30° | 45° |
| Example 1 | 1126 | 1614 | 2081 | 1627 | 1126 |
| Example 2 | 1114 | 1614 | 2081 | 1627 | 1151 |
| Example 3 | 1101 | 1614 | 2068 | 1614 | 1139 |
| Example 4 | 1114 | 1600 | 2081 | 1614 | 1139 |
| Example 5 | 1101 | 1614 | 2081 | 1627 | 1114 |
| Comparable Example 1 | 1177 | 1653 | 2000 | 1666 | 1177 |
| Comparable Example 2 | 1202 | 1653 | 1946 | 1653 | 1189 |
| Comparable Example 3 | 1164 | 1614 | 1959 | 1614 | 1164 |
| Comparable Example 4 | 1177 | 1627 | 1973 | 1640 | 1177 |
| Comparable Example 5 | 1164 | 1600 | 1932 | 1614 | 1177 |
| Comparable Example 6 | 1101 | 1600 | 2095 | 1627 | 1114 |
| Comparable Example 7 | 1139 | 1614 | 2068 | 1627 | 1139 |
| Comparable Example 8 | 1089 | 1535 | 2041 | 1535 | 1101 |
| Comparable Example 9 | 1113 | 1574 | 2068 | 1574 | 1126 |
| Comparable Example 10 | 1101 | 1561 | 2054 | 1561 | 1101 |
| Reference Example 1 | 1227 | 1627 | 1745 | 1614 | 1240 |
| Reference Example 2 | 1214 | 1627 | 1745 | 1640 | 1265 |
| Reference Example 3 | 1227 | 1627 | 1719 | 1640 | 1252 |
| Reference Example 4 | 1202 | 1600 | 1732 | 1627 | 1252 |
| Reference Example 5 | 1227 | 1614 | 1732 | 1653 | 1240 |
| Reference Example 6 | 1303 | 1614 | 1653 | 1627 | 1303 |
| Reference Example 7 | 1316 | 1574 | 1614 | 1587 | 1316 |
| Reference Example 8 | 1278 | 1587 | 1653 | 1587 | 1291 |
| Reference Example 9 | 1291 | 1587 | 1653 | 1587 | 1291 |
| Reference Example 10 | 1278 | 1561 | 1640 | 1574 | 1278 |

As clearly seen from the results mentioned in Table 1, the edge light type backlight units incorporating the optical films of Examples 1 to 5 (using two laminates) showed brightness for the frontal direction higher than that obtained with the optical films of Comparative Examples 1 to 5 (using two laminates) by about 70 to 150 (cd/m²). Moreover, even though the edge light type backlight units incorporating the optical films of Examples to 5 showed higher brightness for the frontal direction, they also showed sufficient light diffusing property, i.e., they showed brightness for the right and left 30° directions comparable to that of the backlight units incorporating the optical films of Comparative Examples 1 to 5, and brightness ratio of about 50% for the right and left 45° directions relative to the frontal direction. Further, the backlight units using the optical films of Examples 1 to 5, each of which was obtained by superimposing two laminates, showed extremely higher brightness for the frontal direction compared with that obtained with those of Reference Examples 1 to 10, each of which was obtained by using one laminate.

Moreover, the optical films of Examples 1 to 5, each of which was obtained by superimposing two laminates, provided comparable or higher brightness for the frontal direction compared with that obtained with the optical films of Comparative Examples 6 to 10, each of which was obtained by superimposing three laminates. Thus, the optical films of Examples 1 to 5 could provide superior brightness for the frontal direction with fewer laminates.

### 3. Production of Direct Type Backlight Units

The optical films of Examples 1 to 5 and Comparative Examples 1 to 10 were each built into a 27-inch direct type backlight unit (1 inch=2.54 cm) comprising 12 cold cathode tubes, and brightness was measured. Specifically, each optical film was installed on a light diffusing material (translucent resin plate) so that the surface of the film on the light diffusing layer side should serve as a light projection surface, and brightness was measured at the center of the backlight unit for the frontal direction and directions inclined by various light projection angles and parallel to the long side direction of the center of the backlight unit. The results obtained with the optical films of Examples 1 to 5 and Comparative Examples 1 to 10 are shown in Table 2 (unit is “cd/m²/m²”). In addition, the results of the same measurement for brightness obtained by installing one each of the laminates used in Examples 1 to 5 and Comparative Examples 1 to 5 on the light diffusing material, respectively, are also shown as results of Reference Examples 1 to 10.

TABLE 2

| | Brightness (cd/m²) | | | | |
|---|---|---|---|---|---|
| | Left | Left | Front | Right | Right |
| | 45° | 30° | (0°) | 30° | 45° |
| Example 1 | 4332 | 6407 | 8619 | 6469 | 4392 |
| Example 2 | 4392 | 6469 | 8554 | 6656 | 4452 |
| Example 3 | 4332 | 6531 | 8554 | 6656 | 4512 |
| Example 4 | 4272 | 6407 | 8554 | 6469 | 4452 |
| Example 5 | 4212 | 6407 | 8554 | 6594 | 4392 |
| Comparable Example 1 | 4693 | 6781 | 8426 | 6843 | 4814 |
| Comparable Example 2 | 4693 | 6656 | 8298 | 6781 | 4874 |
| Comparable Example 3 | 4452 | 6345 | 8170 | 6656 | 4753 |
| Comparable Example 4 | 4632 | 6594 | 8170 | 6594 | 4693 |
| Comparable Example 5 | 4572 | 6469 | 8170 | 6531 | 4633 |
| Comparable Example 6 | 4332 | 6469 | 8619 | 6594 | 4452 |
| Comparable Example 7 | 4452 | 6407 | 8490 | 6531 | 4572 |
| Comparable Example 8 | 4152 | 6097 | 8234 | 6159 | 4212 |
| Comparable Example 9 | 4332 | 6283 | 8362 | 6345 | 4392 |
| Comparable Example 10 | 4392 | 6159 | 8234 | 6283 | 4512 |
| Reference Example 1 | 4874 | 6906 | 7725 | 6469 | 4392 |
| Reference Example 2 | 4874 | 6718 | 7598 | 6781 | 4935 |
| Reference Example 3 | 4935 | 6781 | 7598 | 6718 | 4935 |
| Reference Example 4 | 4814 | 6781 | 7598 | 6843 | 4935 |
| Reference Example 5 | 4814 | 6781 | 7598 | 6718 | 4814 |
| Reference Example 6 | 5178 | 6843 | 7472 | 6906 | 5361 |
| Reference Example 7 | 5239 | 6843 | 7283 | 6781 | 5300 |
| Reference Example 8 | 5056 | 6718 | 7409 | 6718 | 5178 |
| Reference Example 9 | 5117 | 6718 | 7472 | 6718 | 5117 |
| Reference Example 10 | 5056 | 6656 | 7346 | 6594 | 5300 |

As clearly seen from the results mentioned in Table 2, the direct type backlight units incorporating the optical films of Examples 1 to 5 (using two laminates) showed brightness for the frontal direction higher than that obtained with the optical films of Comparative Examples 1 to 5 (using two laminates) by about 130 to 450 (cd/m²). Moreover, the edge light type backlight units incorporating the optical films of Examples 1 to 5 showed sufficient light diffusing property, i.e., they showed brightness for the right and left 45° directions exceeding 4200 (cd/m²), and brightness ratio of about 50% for the right and left 45° directions relative to the frontal direction. Further, the backlight units using the optical films of Examples 1 to 5, each of which was obtained by superimposing two laminates, showed extremely higher brightness for the frontal direction compared with that obtained with those of Reference Examples 1 to 10, each of which was obtained by using one laminate.

Moreover, the optical films of Examples 1 to 5, each of which was obtained by superimposing two laminates, provided comparable or higher brightness for the frontal direction compared with that provided by the optical films of Comparative Examples 6 to 10, each of which was obtained by superimposing three laminates. Thus, the optical films of Examples 1 to 5 could provide superior brightness for the frontal direction with fewer laminates.

### BRIEF DESCRIPTION OF THE DRAWINGS

[FIG. 1] A sectional view showing an example of the optical film of the present invention

[FIG. 2] A sectional view showing an example of the backlight unit of the present invention

[FIG. 3] A sectional view showing another example of the backlight unit of the present invention

### DESCRIPTION OF NUMERAL SYMBOLS

1, 23, 34 . . . Optical film
2 . . . Edge light type backlight unit
3 . . . Direct type backlight unit

1. An optical film comprising two superimposed two laminates each comprising a transparent support and a light diffusing layer formed from acrylic resin particles and a styrene acrylic copolymer resin binder and provided on the transparent support.

2. The optical film according to claim 1, wherein:
each laminate has a first surface formed by the light diffusing layer, and a second surface opposite the first surface; and the two laminates are superimposed so that the first surface of one laminate and the second surface of the other laminate should face each other.

3. The optical film according to claim 2, wherein:
the laminates each have a backcoat layer on the second surface.

4. The optical film according to claim 3, wherein:
each of the laminates has a haze (JIS K7136:2000) of 85% or more and a total light transmission (JIS K7361-1:1997) of 90% or more.

5. The optical film according to claim 4, wherein:
the styrene acrylic copolymer resin binder has a glass transition temperature of 40° C. or higher.

6. The optical film according to claim 5, wherein:
the light diffusing layer contains an acrylic resin binder having a glass transition temperature of 30° C. or lower.

7. The optical film according to claim 5, wherein:
the acrylic resin particles have a mean particle size of 10 to 30 μm and a coefficient of variation in particle size distribution of 10 to 40%.

8. A backlight unit comprising a light guide plate and a light source at least at one end of the light guide plate, the light guide plate having a surface substantially perpendicular to the one end as a light projection surface and an optical film according to claim 1 disposed on the light projection surface of the light guide plate.

9. The backlight unit according to claim 8, wherein:
the optical film is disposed so that the light diffusing layer is on the light projecting side.

10. A backlight unit comprising a light source, a light diffusing material disposed on one side of the light source, and an optical film according to claim 1 disposed on the side of the light diffusing material opposite to the light source.

11. The backlight unit according to claim 10, wherein:
the optical film is disposed so that the light diffusing layer is on the light projecting side.

12. The optical film according to claim 1 wherein:
the laminates each have a backcoat layer on the surface of the support opposite the light diffusing layer.

13. The optical film according to claim 1, wherein:
each of the laminates has a haze (JIS K7136:2000) of 85% or more and a total light transmission (JIS K7361-1:1997) of 90% or more.

14. The optical film according to claim 2, wherein:
each of the laminates has a haze (JIS K7136:2000) of 85% or more and a total light transmission (JIS K7361-1:1997) of 90% or more.

15. A backlight unit comprising a light guide plate and a light source at least at one end of the light guide plate, the light guide plate having a surface substantially perpendicular to the one end as a light projection surface and an optical film according to claim 2 disposed on the light projection surface of the light guide plate.

16. The backlight unit according to claim 15, wherein:
the optical film is disposed so that the light diffusing layer is on the light projecting side.

17. A backlight unit comprising a light source, a light diffusing material disposed on one side of the light source, and an optical film according to claim 2 disposed on the side of the light diffusing material opposite the light source.

18. The backlight unit according to claim 17, wherein:
the optical film is disposed so that the light diffusing layer is on the light projecting side.
